(19) United States
(12) Patent Application Publication
(10) Pub. No.: US 2002/0146126 A1
(43) Pub. Date: Oct. 10, 2002

(54) STEW encryption

(76) Inventor: Stewart Smith, Fairfield, CT (US)

Correspondence Address: Stewart Smith, 149 Wilson Street, Fairfield, CT, 06432-1422, US

(21) Appl. No.: 10/106,340

(22) Filed: Mar. 26, 2002

Related U.S. Application Data
(60) Provisional application No. 60/279,183, filed on Mar. 27, 2001.

(51) Int. Cl. H04K 1/00

(52) U.S. Cl. 380/255

(57) ABSTRACT

STEW Encryption is a new method of securing computerized data that uses the output of dynamic wave functions or similar functions to alter numerical data, most notably computer byte values. STEW is a symmetrical form of encryption, meaning its encryption process is nearly the reverse of its decryption process. This new method, using dynamic wave functions, is much more difficult to crack than current symmetrical encryption methods. It improves security while keeping key lengths and processing requirements to a minimum. STEW can be easily combined with public key (asymmetric) encryption. This makes STEW ideal for quick tasks like sending secure credit card information from a costumer to a store on the Internet.

### CROSS REFERENCE TO RELATED APPLICATIONS

A provisional patent for this invention was filed on Mar. 27, 2001. (Application No. 60/279,183.)

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING COMPACT DISK APPENDIX

Not applicable.

### BACKGROUND OF INVENTION

This invention pertains to the field of data security. STEW Encryption improves on the prior art of symmetrical encryption by providing a secure encryption technique which minimizes complex computation while keeping the size of the encryption key small. The use of multiple wave, (and similar), functions greatly improves the security of the encrypted data over that of the prior symmetrical encryption.

### BRIEF SUMMARY OF INVENTION

The present invention is a method and corresponding system for encrypting and decrypting data so that a data file can be communicated between computers in a reasonably secure way. The invention is called STEW, standing for Simple Transmutation Encrypting Wave (Encryption). A provisional patent for this invention was previously filed.

A system according to the invention includes a computer that executes an encryption algorithm described below and in attachment A. The encryption algorithm accepts as input any sort of (original) data file, and produces as an output an encrypted data file, the encryption being based on one or more keys associated with the intended recipient of the file.

According to the invention, the intended recipient has a computer read the encrypted data file that is provided for example over the Internet, but could also be mailed in electronic form (on a floppy disk) or could be provided over a local area network. The computer operated by the intended recipient then executes a decryption algorithm according to the invention, to provide the original data file. The decryption algorithm uses keys to decrypt the data file, and in the preferred embodiment, the keys used to decrypt the encrypted data file are the same as are used to encrypt the original file.

### FIGURE DESCRIPTIONS

These figures demonstrate a simplified static version of the encryption. This particular version of the encryption process focuses on bytes of data and uses a sine wave to alter the numerical contents of each byte. Because this version of the encryption is static, it does not contain dynamic variables or secondary wave equations, or an encryption key. (In this instance the equation is the key itself.) This simplified version of STEW Encryption is provided as a stepping stone to understanding the more complex dynamic version described in this paper. See accompanying graph and numerical tables sheets for the following listed figures.

FIG. 01. Graph of Plain-Text File.

Visual representation of a Plain-Text file containing the text “Text123” followed by a NULL character. The x-axis marks the first 8 bytes, or characters, of the file. The y-axis represents the ASCH value of each byte which exists between 0 and 255 inclusive.

FIG. 02. Contents of Plain-Text File.

Numerical table of a Plain-Text file containing the text “Text123” followed by a NULL character. The “Address” column marks the first 8 bytes, or characters, of the file. The “ASCII value” column shows what value each byte contains, (between 0 and 255 inclusive). The “Character” column displays the characters that correspond to each ASCII value. Ex. 84=“T”.

FIG. 03. Graph of Encryption Wave.

Visual representation of a simplified encryption wave; in this example y=sin(x)*10,000. The x-axis marks the first 8 units of the wave. Wave units are marked in order to establish a correspondence with byte addresses, and in this case the marks directly relate to the x value in the wave equation. The y-axis represents the wave, fitted into an ASCII friendly range of 0 to 255 inclusive. (This is done for visual continuity and has no effect on the encryption process in this case.)

FIG. 04. Encryption Wave Values.

Numerical table of an encryption wave, y sin(x)*10,000. The “X-Axis” column marks the first 8 wave units. The “Y Value” column shows the truncated integer result of the wave equation for each value of x. The “Y Mod 255” column translates these values into an ASCII friendly mod 255 format. (This is done for continuity with the above graph and has no effect on the encryption process in this case.)

FIG. 05. Graph of Crypto-Text File.

Visual representation of a Crypto-Text file containing the text [ETX]+“−à0”+[ACK]+“K.t”, where [ETX] and [ACK] represent special command characters without visual representations. The x-axis marks the first 8 bytes, or characters, of the file. The y-axis represents the ASCII value of each byte which exists between 0 and 255 inclusive.

FIG. 06. Contents of Crypto-Text File.

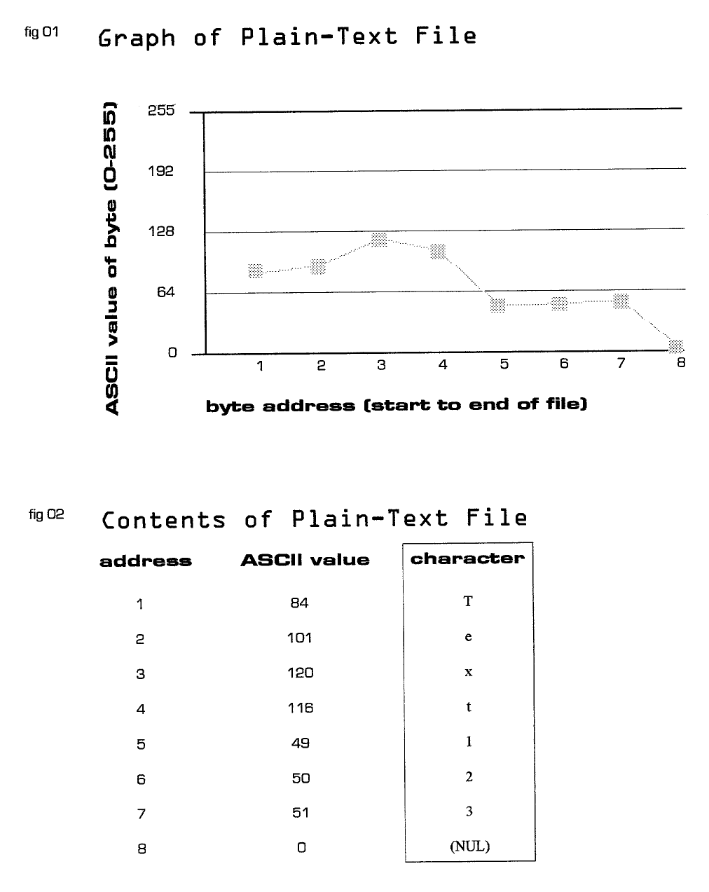

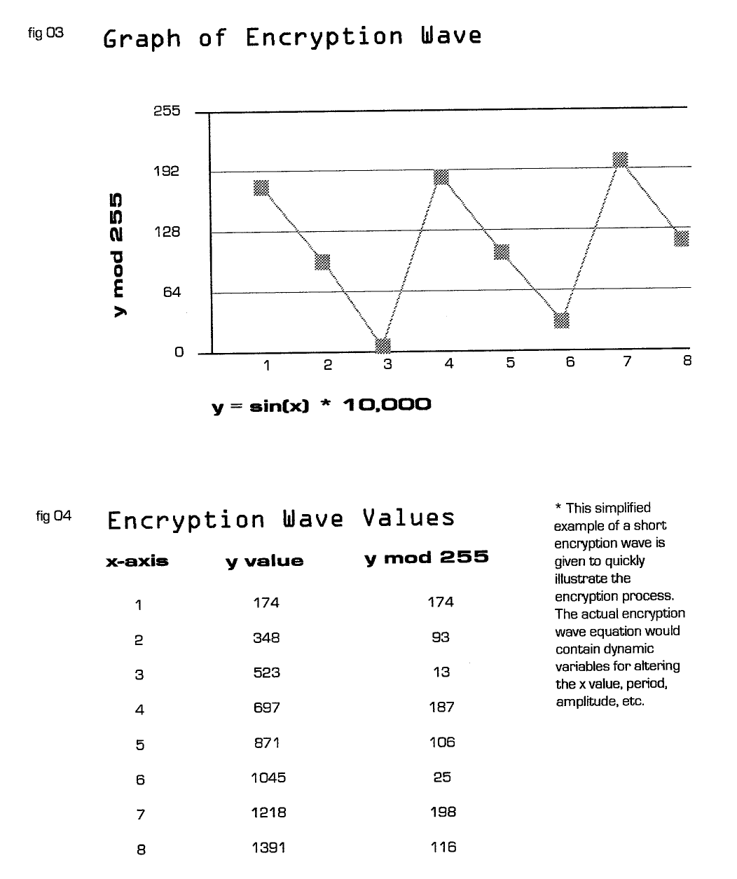

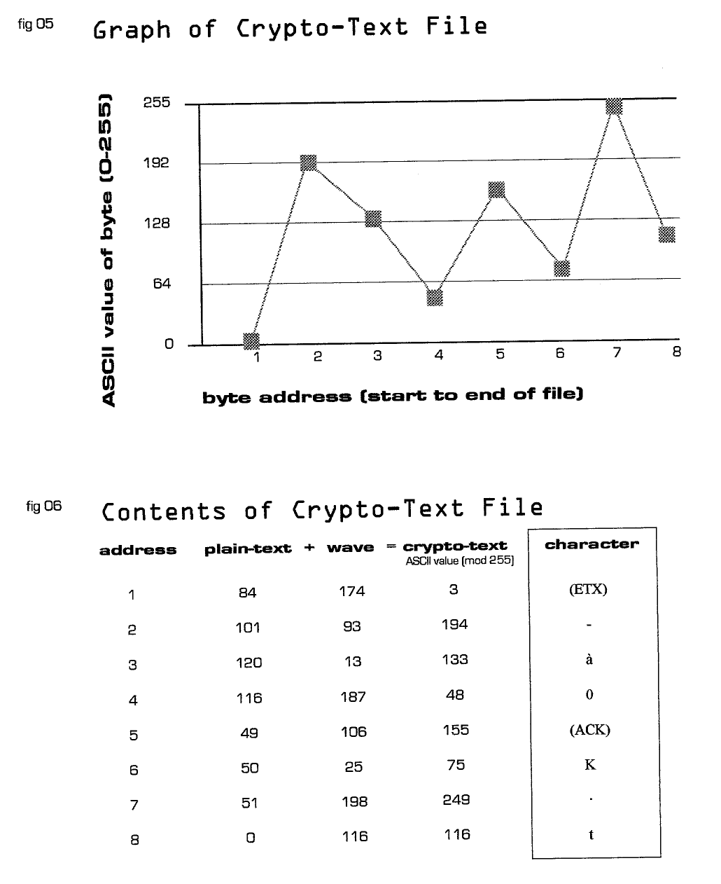

Numerical table of a Crypto-Text file containing the text [ETX]+“−à0”+[ACK]+“K.t” where [ETX] and [ACK] represent special command characters without visual representations. The “Address” column marks the first 8 bytes, or characters, of the file. The “Plain-Text” column recalls the ASCII values of the original Plain-Text file. The “+Wave” column indicates the mathematical addition of each ASCII value of the Plain-Text file to the according value of the encryption wave. The “=Crypto-Text” column reveals the result of the addition, with each sum placed into an ASCII friendly mod 255 format. The “Character” column displays the corresponding ASCII character. Ex. 3=the special character known as ETX.

### DETAILED DESCRIPTION OF INVENTION

Various aspects of the invention will now be described. The algorithm used by the invention is here called STEW, standing for Simple Transmutation Encryption Wave (Encryption). STEW encryption relies on one or another mathematical function to generate a predictable series of numbers. Examples of such a function include a sine function or other trigonometric function, or one or another Bessel function, or a hyperbolic trigonometric function, or the so-called gamma function, or any of the so-called special functions, but any mapping which for each input value will yield a predictable output value can be used, as opposed to a function for which the mapping is indeterminate. In other words, any mapping which always yields the same output for the same input can be used. Preferably, though, functions that are easy to compute are used. The output values of the function are then used to alter the numerical representation of the original data file, byte by byte, or bit by bit, as explained below. The preferred mode of STEW is a computer program with the following characteristics:

Encryption Keys.

STEW creates an encryption key pair based on random values. (Public Key Encryption is already a publicly established means of creating Encryption Key Pairs.) The Key is then stored on a transportable media, such as a disk or “USB Keys”, a recent technology, which uses a USB Plug with data storing capabilities to store small amounts of data. STEW then uses these Keys to encrypt and decrypt data. The Keys themselves are essentially compiled numeric values, which STEW plugs into equations during the encrypting and decrypting processes.

Encryption Process.

STEW uses a sine wavefunction (or any other mathematical function which produces a predictable series of numbers). The input, called here the x value, of the sine function is a dynamically changing variable that is altered each time the encryption algorithm is processed, according to the specifications in the encryption key.

The mathematical function used must be alterable in predictable ways. For example, STEW's preferred method of encryption is to use the sine function and its properties for altering the period, amplitude, etc. These properties of the wave are controlled by dynamic variables that change value during the encryption process. Each cycle of the algorithm changes these dynamic variables.

These dynamic variables are controlled by their own predictable mathematical functions, which will be referred to here as secondary equations. For example, each of these variables may be the result of a secondary sine equation. The x variable, as well as the variables for altering the period, amplitude, etc., for these secondary equations is determined by the key.

In this preferred mode example, STEW uses a sine wave for the primary equation. The characteristics of this wave are based on secondary sine waves. These characteristics of the secondary equation are based on the encryption key.

The value taken from the primary encryption wave during a single cycle of the encryption algorithm is added, subtracted, multiplied, etc., to the value of the current data block according to the encryption key's specification.

Thus, if x is a byte of the original data file (to be encrypted) and y is the corresponding byte of the encrypted data file, then in the preferred embodiment, the encrypted byte y corresponding to the original byte x is given by,

y=x+F(aₓ, G(k))

where F( . . . ) is a predictable function, aₓ is the address of the byte being encrypted, i.e. the order of the byte in the original data file, G( . . . ) is a predictable function, and k is the key used to encrypt the data file. Thus, the invention is said here to use a composite predictable function, i.e. a predictable function of a predictable function. One particular example of a composite predictable function that can be used in the invention is,

y=x+sin(aₓ*w1+w2)*w3+w4

where aₓ is the address of the byte being encrypted, and where the w1, w2, w3, w4 are values that are determined using,

w=sin(k_{x,1}*k_{x,2}+k_{x,3})*k_{x,4}+k_{x,5}

where the quantities k_{x,1}, k_{x,2}, . . . k_{x,5} are static (constant), and are associated with the key k. The term aₓ need not correspond directly to an address. For example, the actual address may be aₓ*n where n is a value stored in the key. For added security, a reordering technique may be applied to scramble the order of the file's bits or bytes. An elementary example of this would be reversing the file's byte order so that the first byte in the plain text file would be the last byte in the encrypted file, and so on.

As an alternative to RSA-style public key encryption, a data set may be encrypted by Key 1 and sent to the recipient who then further encrypts the data using Key 2. The data is then sent back to the original owner who partially decrypts the contents using Key 1. Then the data is sent back to the recipient who fully decrypts it using Key 2. In this manor encryption keys need not be exchanged. (Key exchange, discounting RSA-style public keys, is a threat to security.) This technique is easily applied to Instant Messaging programs and other active data exchange programs.

Decryption Process.

To decrypt a file encrypted by this process, the encryption key is necessary. STEW looks at the encryption key, plugs in the values from the key into the encryption equation, and reverses the process. If the value given by the primary equation was added to encrypt, it will be subtracted to decrypt. Decrypting is a simple reversal of the encryption process. Symbolically, in an embodiment where the composite predictable function value is added to the input byte (or bit), the decryption is simply,

y=x−F(aₓ, G(k))

in which the predictable composite function F(aₓ, G(k)) can be computed without knowing x; only the position of x in the original data file that must be known, and that position is the same as the position of the corresponding y in the encrypted data file. It is of course also possible that the composite predictable function multiplies the input bytes (or bits) in encrypting the original data file (in which case the composite predictable function would have to be always non-zero), so that the decryption requires that division of the encrypted byte (or bit) by the composite predictable function instead of subtracting the composite predictable function from the encrypted byte (or bit).

In addition, any other kind of binary mathematical operation (i.e. an operation for combining two values) having an inverse operation can be used instead of simple arithmetic addition.

Intended Form and Function

The invention is a system that is operative to encrypt data using a STEW algorithm. The STEW algorithms differ because of using either different composite predictable functions and/or different binary operation for combining the value of the composite predictable function with the input byte (or bit) to be encrypted. The invention can be used to encrypt private files and documents, such as email, expense reports, etc. Any computer file that needs to be kept private can be encrypted using this process. This would make it safe to transport a sensitive file through relatively insecure means, such as email. The file is encrypted, transported, and the end user decrypts it using a decrypt key. (In the preferred embodiment, the invention uses the concept of Encryption and Decryption Key Pairs based on the publicized practice of Public Key Encryption.)

The STEW algorithm can be modified for use within other programs. It would be useful for web pages to use STEW encryption to encrypt credit card numbers so that their transfer over the internet would be secure.

STEW could also be used for a method of software copy protection. For example, a web page that is only accessible to users of a registered piece of software could be encrypted. The decode key would be extracted from bits of data within the registered piece of software. Therefore, only those who own the software would have the key to open up the web page.

In addition, any other kind of binary mathematical operation (i.e. an operation for combining two values) having an inverse operation can be used instead of simple arithmetic addition.

Intended Form and Function

The invention is a system that is operative to encrypt data using a STEW algorithm. The STEW algorithms differ because of using either different composite predictable functions and/or different binary operation for combining the value of the composite predictable function with the input byte (or bit) to be encrypted. The invention can be used to encrypt private files and documents, such as email, expense reports, etc. Any computer file that needs to be kept private can be encrypted using this process. This would make it safe to transport a sensitive file through relatively insecure means, such as email. The file is encrypted, transported, and the end user decrypts it using a decrypt key. (In the preferred embodiment, the invention uses the concept of Encryption and Decryption Key Pairs based on the publicized practice of Public Key Encryption.)

The STEW algorithm can be modified for use within other programs. It would be useful for web pages to use STEW encryption to encrypt credit card numbers so that their transfer over the internet would be secure.

STEW could also be used for a method of software copy protection. For example, a web page that is only accessible to users of a registered piece of software could be encrypted. The decode key would be extracted from bits of data within the registered piece of software. Therefore, only those who own the software would have the key to open up the web page.

1. I claim as my invention, the process of using the output of dynamic wave functions or similar functions to alter numerical data, most notably computer byte values, in order to encrypt and decrypt data.
